(19) United States
(12) Patent Application Publication
(10) Pub. No.: US 2009/0322798 A1
(43) Pub. Date: Dec. 31, 2009

(54) FLAT PANEL DISPLAYS

(75) Inventors: Chun-Hsu Lin, Tainan City (TW); Chih-Yung Hsieh, Tainan County (TW); Chien-Hong Chen, Tainan City (TW)

Correspondence Address: FISH & RICHARDSON PC, P.O. BOX 1022, MINNEAPOLIS, MN, 55440-1022, US

(73) Assignee: Chi Mei Optoelectronics Corporation, Tainan County (TW)

(21) Appl. No.: 12/435,045

(22) Filed: May 4, 2009

(30) Foreign Application Priority Data
Jun. 30, 2008 (TW) 97124625

(51) Int. Cl. G09G 5/10

(52) U.S. Cl. 345/690; 345/89

(57) ABSTRACT

A display includes pixels, each pixel including a first display region and a second display region. A controller controls driving of the first and second display regions of each pixel to set the gray scale levels of the first and second display regions based on an overall gray scale level to be shown by the pixel. The controller sets the gray scale level of the second display region independently of the gray scale level of the first display region.

### CROSS REFERENCE TO RELATED APPLICATIONS

This application claims priority to Taiwan application Serial No. 097124625, filed Jun. 30, 2008. The entire content of the above application is incorporated by reference.

### BACKGROUND

The description relates to flat panel displays.

Flat panel displays can be thin, light weight, consume low power, and be used in various electronic products. Flat panel displays include, e.g., liquid crystal displays, plasma displays, organic light emitting diode displays, field emission displays, surface conduction electron emitter displays, and carbon nanotube field emission displays.

In some examples of liquid crystal displays, pixel voltages are provided to control the orientations of liquid crystal molecules in pixels resulting in various light polarizing or refracting effects so as to control the transmission of light through the pixels. This enables the liquid crystal display to show images with various gray scale levels or colors. The relationship between the light transmittance of a pixel and the pixel voltage can be non-linear. A color liquid crystal display can include sub-pixels for the three primary colors (e.g., red, green, and blue), and each primary color can be associated with its own gamma curve. The gamma curve for a particular color represents a relationship between the input gray scale levels and the transmittance of pixels for the particular color.

FIG. 1 is a graph 10 that shows gamma curves (e.g., 12 and 14) of a liquid crystal display for the three primary colors at a front viewing angle (corresponding to a direction perpendicular to the display surface) and a side viewing angle (at an angle away from the perpendicular direction). The horizontal axis represents the input gray scale levels, which corresponds to the pixel voltages that are provided to the pixels. The vertical axis represents the transmittance of the pixels. Higher gray levels correspond to higher transmittance and higher luminance or brightness. As can be seen from the curves 12 and 14, when the viewing angle of the display is changed from a front viewing angle to a side viewing angle, the ratios for the primary colors may change. Because the overall color seen by the viewer is based on a combination of the primary colors, when the ratios of the primary colors change when the viewing angle changes, the same gray scale level may correspond to different colors at different viewing angles. Also, the curve 14 indicates that when the display is viewed from a side viewing angle, the offsets among the primary colors change abruptly at around gray-scale level 100, so the color may not be uniform across various gray-scale levels.

For example, if a liquid crystal display is capable of displaying gray scale levels ranging from 0 to 255, and an input pixel voltage corresponding to the gray scale level of 128 is provided to the red, green, and blue sub-pixels, the pixel is perceived to have an overall gray color when viewed from the front viewing angle, and have another color (e.g., indigo) when viewed from a certain side viewing angle because the gamma curves for the three primary colors have different offsets. Here, the offset refers to the change in transmittance from the front viewing direction to the side viewing direction. The offset of the gamma curve is larger at the intermediate gray scale levels and is smaller at the higher or lower gray scale levels. For example, the intermediate gray scale levels can range from 64 to 196, the higher gray scale levels can range from 197 to 255, and the lower gray scale levels can range from 0 to 63.

### SUMMARY

In one aspect, in general, a pixel is divided into a first display region and a second display region. The pixel is driven such that the first display region is driven by a pixel voltage corresponding to a gray scale level higher than an intended gray scale level, and the second display region is driven by a pixel voltage corresponding to a gray scale level lower than the intended gray scale level, resulting in the pixel showing an overall intermediate gray scale level, which is the intended gray scale level.

In some examples, the pixel includes a first transistor, a second transistor, and a third transistor electrically coupled to a first scan line, a second scan line, and a data line. The first display region is electrically coupled to the data line and the first scan line, and the second display region is electrically coupled to the data line, the first scan line, and the second scan line.

The pixel can be driven as follows. In a first time duration, a first driving signal is provided through the first scan line, and a second driving signal is provided through the second scan line. This turns on the first, second, and third transistors, allowing pixel data to be written into the first display region and the second display region through the data line. In a second time duration, a third driving signal is provided through the second scan line to turn on the third transistor so that charges stored in capacitors connected to two sides of the third transistor are redistributed and changing the voltage level at the second display region.

In another aspect, in general, an apparatus includes a display, which includes pixels each including a first display region and a second display region. A controller controls driving of the first and second display regions of each pixel to set the gray scale levels of the first and second display regions based on an overall gray scale level to be shown by the pixel. The controller sets the gray scale level of the second display region independently of the gray scale level of the first display region.

Implementations of the apparatus may include one or more of the following features. The display may include a look-up table that stores input gray scale values and corresponding gray scale levels of the first and second display regions, and the controller determines the gray scale levels for the first and second display regions based on the values in the look-up table.

The first display region may be associated with a first capacitor, the second display region may be associated with a second capacitor and a third capacitor, the voltage level on the first capacitor may determine the gray level shown by the first display region, and the voltage level on the second capacitor may determine the gray level shown by the second display region. The controller may set the gray scale levels of the first and second display regions by causing a first voltage level to be stored in the first and second capacitors and a second voltage level to be stored in the third capacitor, then causing the second and third capacitors to be electrically connected such that charges in the second and third capacitors are redistributed between the second and third capacitors.

The first display region may be associated with a first transistor electrically coupled to a first capacitor, the second display region may be associated with a second transistor electrically coupled to a second capacitor and a third transistor electrically coupled to a third capacitor. In some examples, the controller may turn on the first and second transistors for the same duration of time and turn on the third transistor for a duration of time that is different from the duration of time that the second transistor is turned on. In some examples, the controller may apply the same gate voltage to the first and second transistors and apply a gate voltage to the third transistor that is different from the gate voltage applied to the second transistor.

The first display region may be associated with a first transistor and a first capacitor, the first transistor having a gate terminal electrically coupled to a first scan line, a drain terminal electrically coupled to a data line, and a source terminal electrically coupled to the first capacitor, the first capacitor for storing a voltage level corresponding to the gray scale level of the first display region. The second display region may be associated with a second transistor and a second capacitor, the second transistor having a gate terminal electrically coupled to the first scan line, a drain terminal electrically coupled to the data line, and a source terminal electrically coupled to the second capacitor, the second capacitor for storing a voltage level corresponding to the gray scale level of the second display region. The second display region may be associated with a third transistor having a gate terminal electrically coupled to a second scan line, a drain terminal electrically coupled to the source terminal of the second transistor, and a source terminal electrically coupled to a third capacitor. The controller may control the first and second scan lines and the data line to turn on the first, second, and third transistors and cause voltage levels to be stored in the first, second, and third capacitors during a first time period, then control the first and second scan lines to turn off the first and second transistors and turn on the third transistor to cause charges to be redistributed between the second and third capacitors during a second time period. In some examples, the controller may control the first and second scan lines such that the second transistor is turned on for a length of time that is different from the length of time that the third transistor is turned on. In some examples, the controller may control the first and second scan lines such that the voltage level on the first scan line is different from the voltage level on the second scan line while configuring a gray scale level of a pixel.

Each pixel may include a liquid crystal cell.

In another aspect, in general, a method of driving a display includes, for a given input gray level, determining a first gray level for a first display region of a pixel and a second gray level for a second display region of the pixel; and driving the first and second display regions of each pixel to cause the first display region to have the first gray level and the second display region to have the second gray level such that the pixel has an overall gray level that approximates the input gray level.

Implementations of the method may include one or more of the following features. Determining the first gray level for the first display region and the second gray level for the second display region may include searching a look-up table stored in memory to determine the first and second gray levels that correspond to the input gray level.

Driving the first and second display regions may include writing a first voltage level to a first capacitor associated with the first display region, writing the first voltage level to a second capacitor and a third capacitor associated with the second display region, and redistributing charges in the second and third capacitors.

Driving the first and second display regions may include, within a first period of time, driving a first scan line to turn on a first transistor associated with the first display region and a second transistor associated with the second display region, and driving a second scan line to turn on a third transistor associated with the second display region. Within a second period of time, the first transistor and the second transistor are turned off, and the third transistor is turned on to allow charge redistribution to adjust a gray level of the second display region. In some examples, driving the first scan line and the second scan line may include, during the first period of time, turning on the third transistor for a length of time that is different from the length of time that the first and second transistors are turned on during the first period of time. In some examples, driving the first scan line and the second scan line may include, during the first period of time, driving the first scan line using a first voltage and driving the second scan line using a second voltage that is different from the first voltage.

Driving the first and second display regions of a pixel may include rotating liquid crystal molecules of the first and second display regions.

In another aspect, in general, a method for driving a pixel of a display is provided, the pixel including at least a first transistor, a second transistor, and a third transistor electrically connected to a first scan line, a second scan line, and a data line, the pixel having a first display region and a second display region. The method includes, within a first time period, providing a first driving signal through the first scan line and a second driving signal through the second scan line to turn on the first and second transistors, and writing pixel data into the first display region and the second display region through the data line; and within a second time period, providing a third driving signal through the second scan line to turn on the third transistor to redistribute charges at two sides of the third transistor.

Implementations of the method may include one or more of the following features. Within the first period of time, the first driving signal may change from logic low to logic high at a first starting time, and the second driving signal may change from logic low to logic high at a second starting time that is different from the first starting time.

The first driving signal may have a voltage level that is different from the voltage level of the second driving signal when the first and second driving signals turn on the first and second transistors.

Within the first time period, the first driving signal may be at logic high for a first period of time, and the second driving signal may be at logic high for a second period of time that is different from the first period of time.

In another aspect, in general, a method of driving a pixel is provided, the pixel including a first display region and a second display region, the first display region being associated with a first transistor and a first capacitor, the second display region being associated with a second transistor, a third transistor, a second capacitor, and a third capacitor, the first and second transistors having gate electrodes that are electrically connected to a first scan line, the third transistor having a gate electrode that is electrically connected to a second scan line. The method includes providing a first driving signal through the first scan line and a second driving signal through the second scan line to turn on the first, second, and third transistors, providing pixel data to the data line and writing the pixel data to the first display region and the second display region during a first time period, and providing a third driving signal through the second scan line to turn on the third transistor to enable redistribution of charges at two sides of the third transistor during a second time period.

Implementations of the method may include one or more of the following features. The first driving signal may change from a logic low to a logic high at a first starting time, the second driving signal may change from a logic low to a logic high at a second starting time that is different from the first starting time.

The first driving signal may have a voltage level that is different from the voltage level of the second driving signal when the first and second driving signals turn on the first, second, and third transistors.

The first driving signal may be at logic high for a first period of time, and the second driving signal may be at logic high for a second period of time that is different from the first period of time.

Other aspects can include other combinations of the features recited above and other features, expressed as methods, apparatus, systems, program products, and in other ways.

Advantages may include one or more of the following. Gamma curves can be made more consistent when a display is viewed at various viewing angles. The display can have a high aperture ratio. The display can have a high quality. The cost of the display can be low. The display can be optimized for each input gray level because the gray level of the second display region can be adjusted within a certain range independently of the gray level of the first display region.

### DESCRIPTION OF DRAWINGS

FIG. 1 is a graph showing example gamma curves.

FIG. 2 is a schematic diagram of an example pixel that includes a first display region and a second display region.

FIGS. 3 to 5 are graphs showing example waveforms of signals on scan lines and data lines.

FIG. 6 is a graph showing example gamma curves.

FIGS. 7 and 8 are flow diagrams showing example processes for driving pixels.

FIG. 9 is a graph showing example gamma curves.

FIG. 10 is a schematic diagram of an example flat panel display.

FIG. 11 shows an example gray scale look-up table.

FIG. 12 is a schematic diagram of an example display.

### DETAILED DESCRIPTION

The following describes a display having pixels in which each pixel has a first display region and a second display region, and the first and second display regions show different gray scale levels so that the overall gray scale level of the pixel corresponds to an intended gray scale level. The first display region has a gray level higher than the intended gray level, and the second display region has a gray level lower than the intended gray level. Because the change in gamma curves for different viewing angles is more significant at mid-level gray levels, using a combination of a higher gray level and a lower gray level to approximate an intended intermediate gray level reduces the shifts in gamma curves when the display is viewed from different viewing angles. This allows the display to provide a better viewing experience.

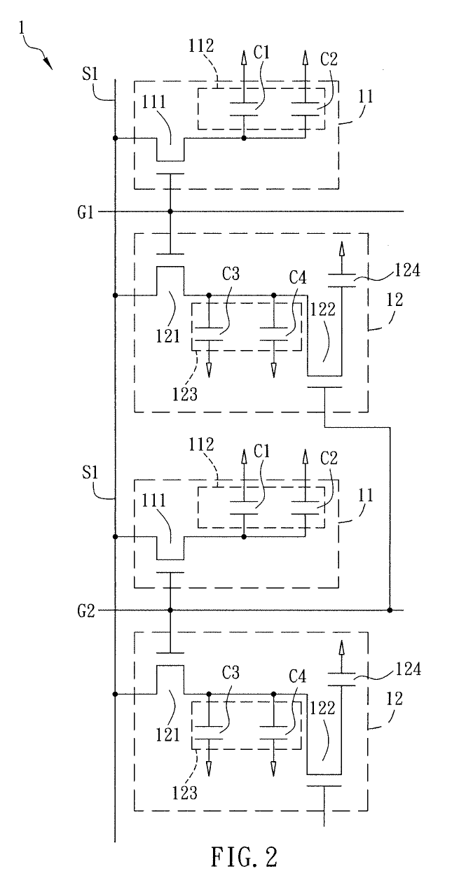

Referring to FIG. 2, an example pixel 1 of a display includes a first display region 11 and a second display region 12. For example, the display can be a liquid crystal display. The first display region 11 is electrically coupled to a data line S1 and a first scan line G1. The second display region 12 is electrically coupled to the data line S1, the first scan line G1, and a second scan line G2. In some implementations, for some of the target gray levels shown by the pixel, the first display region 11 shows a gray level higher than the target gray level of the pixel (the first display region has a luminance level higher than an intended luminance level of the pixel), and the second display region 12 shows a gray level smaller than the target gray level of the pixel (the second display region has a luminance level lower than the intended luminance level of the pixel), such that overall the pixel 1 shows the target gray level (the pixel 1 shows a luminance level substantially equal to the intended luminance level).

The first display region 11 has a first thin film transistor (TFT) 111 and a first pixel capacitor 112. The second display region 12 has a second thin film transistor 121, a third thin film transistor 122, a second pixel capacitor 123, and an auxiliary capacitor 124 (also referred to as a distribution capacitor 124 as it participates in redistribution of the charges on the second pixel capacitor 123). The first pixel capacitor 112 includes a first liquid crystal capacitor C1 and a first storage capacitor C2, and the second pixel capacitor 123 includes a second liquid crystal capacitor C3 and a second storage capacitor C4. In this example, the transistors 111, 121, and 122 are P-type transistors. In other implementations, N-type transistors can also be used.

The first thin film transistor 111 has a gate terminal that is electrically coupled to the first scan line G1, a drain terminal that is electrically coupled to the data line S1, and a source terminal that is electrically coupled to the first pixel capacitor 112. The second thin film transistor 121 has a gate terminal that is electrically coupled to first scan line G1, a drain terminal that is electrically coupled to the data line S1, and a source terminal that is electrically coupled to the second pixel capacitor 123. The third thin film transistor 122 has a gate terminal that is electrically coupled to the second scan line G2, a drain terminal that is electrically coupled to the source terminal of the second transistor 121 and the second pixel capacitor 123, and a source terminal that is electrically coupled to the auxiliary capacitor 124.

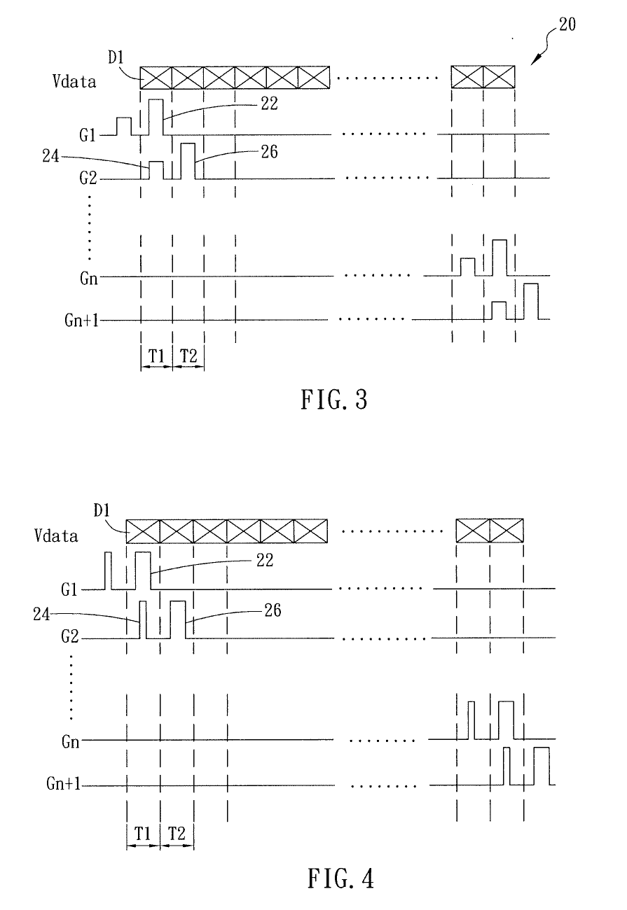

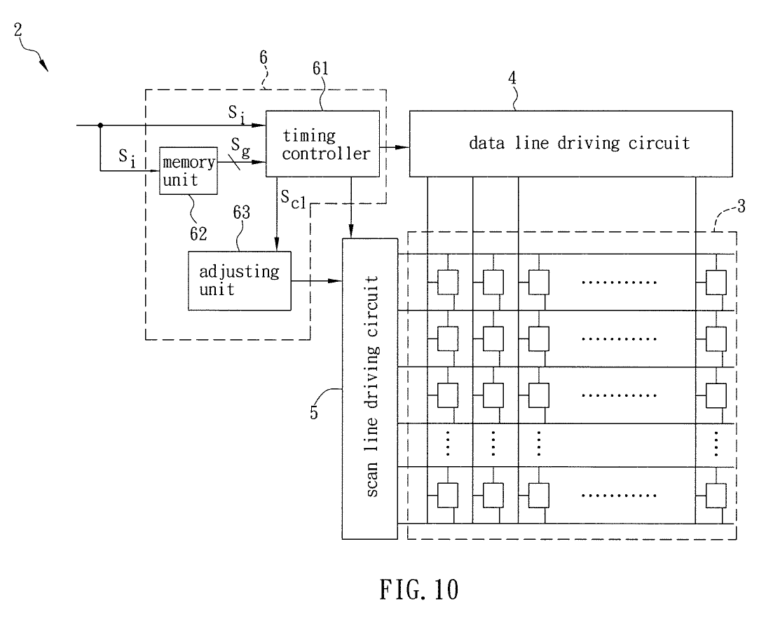

In some implementations, a display having a plurality of pixels 1 can operate as follows. FIG. 3 shows graphs 20 having example waveforms of signals on the scan lines (e.g., G1, G2) and the data line S1. To drive the pixel 1, during a first time period T 1, a scan line driver 5 (see FIG. 10) provides a first driving signal 22 on the first scan line G1 to turn on the first TFT 111 and the second TFT 121. The scan line driver 5 provides a second driving signal 24 on the second scan line G2 to turn on the third TFT 122. After the first and second driving signals 22 and 24 are provided to the first and second scan lines G1 and G2, respectively, a data line driver 4 (see FIG. 10) provides pixel data (Vdata) D1 on the data line S1 and causes the pixel data to be written into the first pixel capacitor 112 and the second pixel capacitor 123 through the first thin film transistor 111 and the second thin film transistor 121, respectively.

The pixel data D1 corresponds to a gray level that is higher than an intended overall gray level to be shown by the pixel 1. The first liquid crystal capacitor C1, the first storage capacitor C2, the second liquid crystal capacitor C3, and the second storage capacitor C4 are charged to a first voltage level representing the pixel data D1. The second driving signal 24 has a voltage level lower than the first driving signal 22 such that the third transistor 122 is not fully turned on, so the voltage stored across the auxiliary capacitor 124 can be different from (e.g., lower than) the voltage stored across the second liquid crystal capacitor C3 and the first storage capacitor C4. In some examples, the amplitude and pulse width of the second driving signal 24 can be varied to adjust the voltage stored in the auxiliary capacitor 124.

During a second time period T2, the voltage level on the first scan line G1 turns low, so the transistors 111 and 121 are turned off. The scan line driver 5 provides a third driving signal 26 through the second scan line G2 to fully turn on the third thin film transistor 122. This allows electric charges to flow through the third thin film transistor 122 and redistribute between the second pixel capacitor 123 and the auxiliary capacitor 124. At the end of the first time period T1, the voltage level of the capacitors C3 and C4 is higher than the voltage level of the capacitor 124, so after charge redistribution, the voltage level of the capacitor C3 and C4 decreases, and the voltage level of the capacitor 124 increases, to an intermediate voltage level.

At the end of the second time period T2, the first liquid crystal capacitor C1 has the first voltage level, and the second liquid crystal capacitor C3 has the intermediate voltage level. The charge redistribution causes the second liquid crystal capacitor C3 to have a voltage level that is lower than the first liquid crystal capacitor C1, so that the second display region 12 shows a gray level that is lower than the target gray level, such that the combination of the first gray level shown by the first display region 11 and the second gray level shown by the second display region 12 corresponds to the intended gray level for the pixel 1.

The voltage difference ΔV between the first voltage level (of the first liquid crystal capacitor C1) and the intermediate voltage level (of the second liquid crystal capacitor C3) can be controlled by controlling either the first voltage level or the intermediate voltage level. The first voltage level is set by the pixel data voltage provided by the data line driver 4. The intermediate voltage level can be controlled by either controlling how much charge is transferred from the capacitor 123 to the capacitor 124 during the second time period T2, or by controlling the voltage level of the capacitor 124 at the end of the first time period T1.

The amount of charge transferred from the capacitor 123 to the capacitor 124 during the second time period T2 can be controlled by controlling the voltage level of the third driving signal 26 or the duration in which the third driving signal 26 is high. When the voltage level of the third driving signal 26 is at an intermediate level such that the third transistor 122 is not fully turned on, or when the third driving signal 26 is high for only a short time period, the amount of charges transferred from the capacitor 123 to the capacitor 124 can be reduced (as compared to using a higher voltage driving signal 26 for a longer duration).

The voltage level of the capacitor 124 at the end of the first time period T1 can be controlled by controlling the voltage level of the second driving signal 24, as shown in FIG. 3. When the second driving signal 24 has an intermediate voltage level such that the third transistor is not fully turned on during the first time period T1, the voltage level stored at the capacitor 124 can be reduced (as compared to using a higher voltage second driving signal 24).

Referring to FIG. 4, the voltage level of the capacitor 124 at the end of the first time period T1 can also be controlled by controlling the time duration of the second driving signal 24 (i.e., the duration in which the second driving signal is high). When the second driving signal 24 is high for a short duration, there may not be enough time for the capacitor 124 to be fully charged to the first voltage level corresponding to the pixel data D1 provided by the data line driver 4.

In some examples, the rising edge of the second driving signal 24 may occur at a time different from the rising edge of the first driving signal 22, and the duration in which the first and second driving signals remain high may be different.

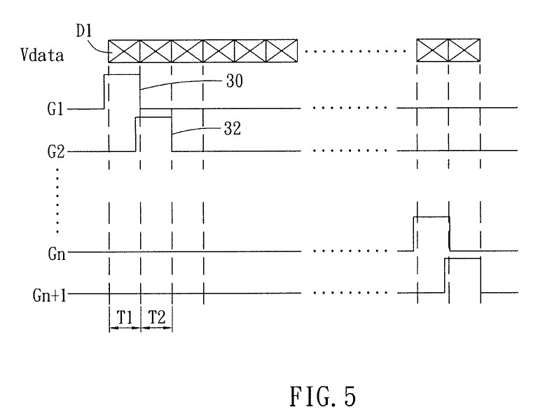

Referring to FIG. 5, in some implementations, the scan line driver 5 provides a first driving signal 30 on the first scan line G1 in which the rising edge of the first driving signal 30 occurs slightly earlier than the beginning of the first time period T1. The falling edge of the driving signal 30 occurs at the end of the first time period T1.

The scan line driver 5 provides a second driving signal 32 on the second scan line G2 in which the rising edge of the second driving signal 32 occurs slightly earlier than the beginning of the second time period T2. The first and second driving signals 30, 32 overlap for a short period of time in which the auxiliary capacitor 124 is charged. By varying the time period in which the first driving signal 30 and the second driving signal 32 overlaps, the amount of charge in the capacitor 124 and hence the voltage level of the capacitor 124 can be adjusted.

In some implementations, the third thin film transistor 122 is configured differently from the first and second transistors 111 and 121 such that the turn-on current of the third thin film transistor 122 is smaller than that of the transistors 111 and 121. This allows the third transistor 122 to draw less power, thereby reducing the overall power consumption of the display. For example, the TFT 122 can have a smaller size or width-to-length ratio (W/L ratio), than the TFTs 111 and 121.

Adjusting the voltage difference ΔV between the first voltage level (of the first liquid crystal capacitor C1) and the intermediate voltage level (of the second liquid crystal capacitor C3) can compensate for differences in the gamma curves for front and side viewing angles, thereby reducing the inconsistencies in colors when the display is viewed from the front and side viewing angles.

The gray levels shown by the first and second display regions 11 and 12 can be adjusted depending on the ratio of the transparent (light-permeable) areas in the first and second display regions 11 and 12 that allow backlight to pass. For example, suppose the transparent areas of the first and second display regions 11 and 12 are the same, the display can be configured to drive the first and second display regions 11 and 12 to show gray levels of, e.g., 200 and 60, respectively, resulting in an overall gray level of 128. Suppose the transparent area of the first display region 11 is larger than the transparent area of the second display region 12. The display can be configured to drive the first and second display regions 11 and 12 to show gray levels of, e.g., 190 and 50, respectively, still resulting in an overall gray level of 128.

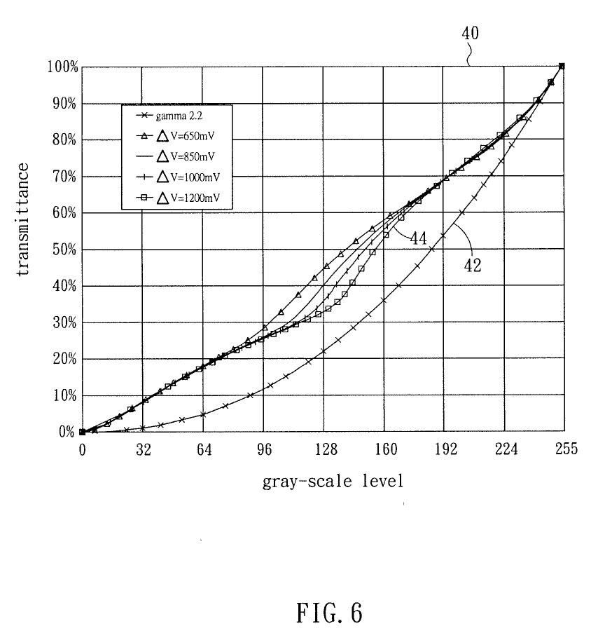

FIG. 6 shows a graph 40 showing gamma curves (e.g., 42 and 44) of the pixel 1 when viewed at a side viewing angle for various ΔV values when the voltage of the first liquid crystal capacitor C1 is equal to 7V (volts) and the wavelength of the backlight being measured is about 550 nm.

The gamma curves in FIG. 6 are for a viewing angle phi=60° and theta=0° in polar coordinates. Phi represents the angle between the viewing direction and the direction normal to the display surface projected on a plane that is perpendicular to the display surface and parallel to a row direction. Theta represents the angle between the viewing direction and the direction normal to the display surface projected on a plane that is perpendicular to the display surface and parallel to a column direction.

In FIG. 6, the side-view gamma curve 44 corresponding to the voltage difference ΔV=1200 mV varies abruptly (the curve 44 turns abruptly) near the gray scale value of 128, so the color variation may be significant when viewed at the side viewing angle. In some examples, a gamma curve is chosen in which the voltage difference ΔV is between about 650 mV to 850 mV. The transmittance variations corresponding to the side-view gamma curve in the high and low gray scale value areas are very small. Here, the transmittance variations refer to the variations of the gamma curves for different ΔV values (e.g., 0, 650, 850, 1000, and 1200 mV). FIG. 6 shows that when ΔV is increased, the transmittance curve becomes less smooth. When ΔV=650 mv, the pixel has a higher transmittance, so the brightness and the contrast ratio are increased. Thus, the voltage difference ΔV can be decreased to increase the brightness and the contrast ratio. In some examples, the voltage difference ΔV is decreased to increase the brightness and the contrast ratio when the pixel set 1 displays colors other than white or the skin color (this is because increasing the transmittance may result in color shift, and color shift for white or skin color is more easily detected by the viewer).

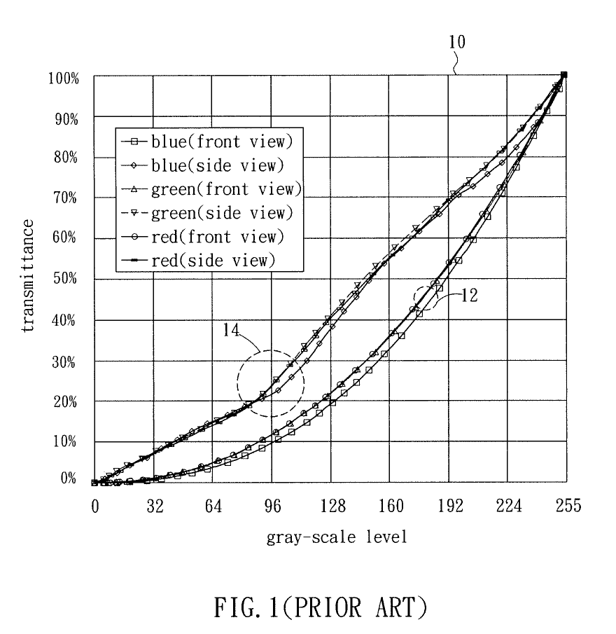

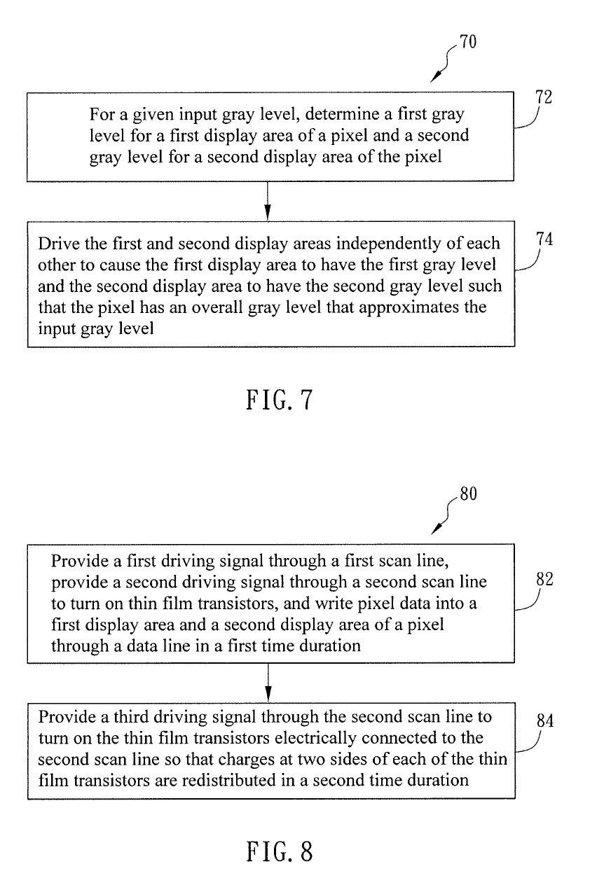

FIG. 7 shows a flow diagram of an example process 70 for driving a pixel of a display. For example, the pixel can be the pixel 1 of FIG. 1. The process 70 includes the following. For a given input gray level, determine a first gray level for a first display region of a pixel and a second gray level for a second display region of the pixel (72). Drive the first and second display regions to cause the first display region to have the first gray level and the second display region to have the second gray level such that the pixel has an overall gray level that approximates the input gray level (74).

For example, the first display region can be the first display region 11 of FIG. 2, and the second display region can be the second display region 12. The display can be a liquid crystal display. Determining the first gray level for the first display region and the second gray level for the second display region can include searching a look-up table stored in memory to determine the first and second gray levels that correspond to the input gray level. The memory can be the memory unit 62 of FIG. 10. Driving the first and second display regions can include writing a first voltage level to a first capacitor associated with the first display region, writing the first voltage level to a second capacitor and a third capacitor associated with the second display region, and redistributing charges in the second and third capacitors. The first capacitor can be the capacitor 112, the second capacitor can be the capacitor 123, and the third capacitor can be the capacitor 124.

Driving the first and second display regions can include, within a first period of time, driving a first scan line to turn on a first transistor associated with the first display region and a second transistor associated with the second display region, and driving a second scan line to turn on a third transistor associated with the second display region. Within a second period of time, turn off the first transistor and the second transistor, and turn on the third transistor to allow charge redistribution to adjust a gray level of the second display region. For example, the first scan line can be the scan line G1 of FIG. 2, the first transistor can be the transistor 111, the second transistor can be the transistor 121, the second scan line can be the scan line G2, and the third transistor can be the transistor 122.

For example, driving the first scan line and the second scan line can include, during the first period of time, turning on the third transistor for a length of time that is different from the length of time that the first and second transistors are turned on during the first period of time. For example, as shown in FIG. 4, the second driving signal 24 causes the transistor 122 to be turned on for a length of time that is shorter than the length of time that the transistors 111 and 121 are turned on by the first driving signal 22.

For example, driving the first scan line and the second scan line can include, during the first period of time, driving the first scan line using a first voltage and driving the second scan line using a second voltage that is different from the first voltage. For example, as shown in FIG. 3, the first driving signal 22 has a voltage level that is different from the voltage level of the second driving signal 24.

FIG. 8 shows a flow diagram of an example process 80 for driving pixels of a display. The process 80 includes providing a first driving signal through a first scan line, providing a second driving signal through a second scan line to turn on thin film transistors, and writing pixel data into a first display region and a second display region of each pixel through a data line in a first time duration (82).

For example, the first scan line can be the scan line G1, the second scan line can be the scan line G2, the first driving signal can be the first driving signal 22, the second driving signal can be the second driving signal 24, the first display region can be the first display region 11, the second display region can be the second display region 12, the data line can be the data line S1, and the transistors can be the transistors 111, 121, and 122. Writing pixel data into the first display region can include writing the pixel data to the capacitors C1 and C2. Writing pixel data into the second display region are can include writing the pixel data to the capacitors C3 and C4.

The process 80 further includes providing a third driving signal through the second scan line to turn on the thin film transistors electrically connected to the second scan line so that charges at two sides of each of the thin film transistors are redistributed in a second time duration (84). For example, the third driving signal can turn on the thin film transistor 122, and charges stored in the capacitors 123 and 124 can be redistributed to cause the voltage level stored in the capacitor 123 to be lower than the voltage level stored in the capacitor 112.

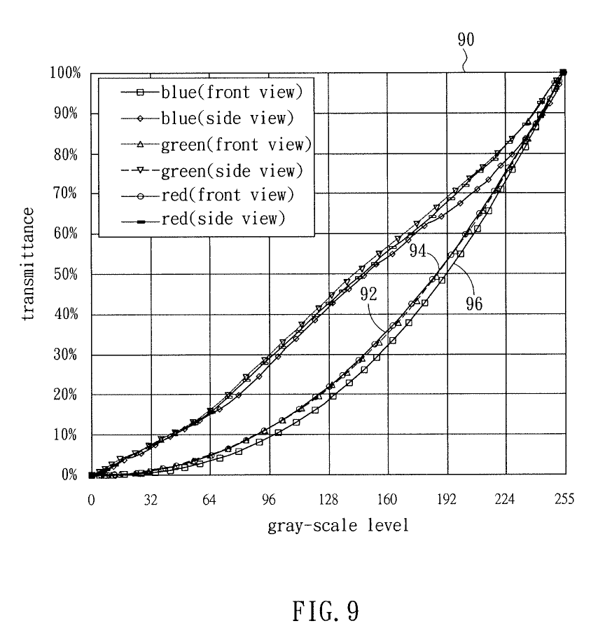

FIG. 9 is a graph 90 having gamma curves (e.g., 92) for various primary colors corresponding to two different viewing angles. Gamma curves 92, 94, 96 for the red, green and blue primary colors are very close to one another. Compared with FIG. 1, the turning portion (indicated by the circle in dashed line of FIG. 1) corresponding to the side-view gamma curve of blue is less obvious (the gray scale values 96 to 128 and the gray scale values 160 to 192), i.e., the gamma curve is smoother and there is no abrupt turn in the curve. Thus, the offsets of the side-view gamma curves of the red, green and blue primary colors are closer to one another, and the ratios of the primary colors are more consistent across various viewing angles.

Referring to FIG. 10, an example flat panel display 2 can include a display panel 3, a data line driver 4, a scan line driver 5, and a driving controller 6. For example, the display 2 can be a liquid crystal display. The display panel 3 can have pixels 1 shown in FIG. 2 that can be driven using the process 70 (FIG. 7) described above. The data line driver 4 and the scan line driving circuit 5 are electrically coupled to the display panel 3. The driving controller 6 is electrically coupled to the data line driver 4 and the scan line driver 5.

In some implementations, the driving controller 6 includes a timing controller 61, a memory unit 62, and an adjusting unit 63. The timing controller 61 receives an input gray scale level Si and controls the data line driver 4 and the scan line driver 5 according to the input gray scale level Si.

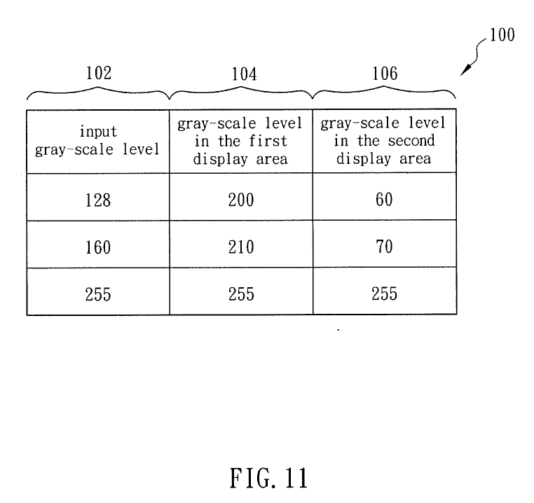

In some implementations, the memory unit 62 stores a gray scale look-up table 100 (see FIG. 11). The memory unit 62 includes a logic circuit that receives the input gray scale level Si, searches up the look-up table 100, and outputs a corresponding compensation gray scale set Sg (which includes two values). The compensation gray scale set Sg can be used to make the side-view gamma curves of the red, green, and blue primary colors of the display panel 3 closer to one another. For example, if the input gray scale level Si is 128, the logic circuit checks the look-up table 100, determines that the corresponding compensation gray scale set Sg is (200, 60), and outputs the values 200 and 60 to the timing controller 61. The first and second display regions 11 and 12 are driven to have gray scale levels 200 and 60, respectively, to cause the pixel 1 to show an overall gray level of 128. Because the color shifts for gray levels 60 and 200 at various viewing angles are smaller than the color shift for gray level 128, this method allows the display to have a better performance at wide viewing angles. The memory unit 62 can be, e.g., read only memory, electrically erasable read only memory (EEPROM), or flash memory.

The timing controller 61 receives the compensation gray scale set Sg, and sends a control signal Sc1 to the adjusting unit 63 according to the compensation gray scale set Sg. The adjusting unit 63 adjusts the waveforms of the first driving signal and the second driving signal according to the control signal Sc1. For example, the adjusting unit 63 can provide control signals to the scan line driver 5 to control the pulse width and/or amplitude of the gate line driving signals. The adjusting unit 63 may also be integrated into the timing controller 61 or the scan line driving circuit 5.

Referring to FIG. 11, the gray scale look-up table 100 includes values for input gray scale levels 102, values for gray scale levels in the first display region 104, and values for gray scale levels in the second display region 106. Only a portion of the gray scale look-up table is shown in the figure, there can be many other entries in the table 100.

The gamma curves for the display can be modified by changing the values in the look-up table 100. For example, values for gray scale levels in the first display region 104 and values for gray scale levels in the second display region 106 can be modified to achieve different gamma curves.

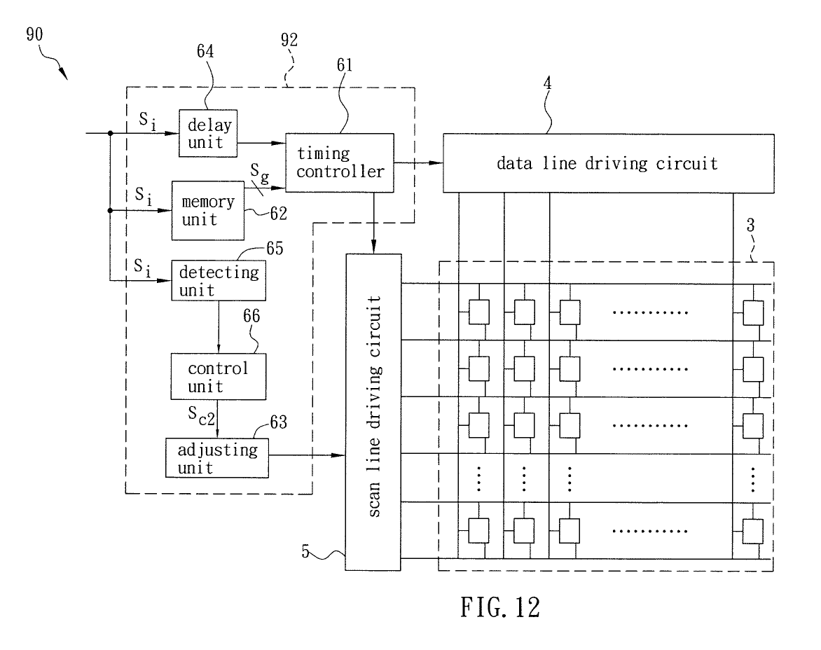

FIG. 12 is a schematic diagram of an example display 90 that has a wide viewing angle with a small amount of color shift at various viewing angles. The display 90 is similar to the display 2 of FIG. 10, except that the display 90 includes a driving controller 92 that has a delay unit 64, a detecting unit 65, and a control unit 66. The detecting unit 65 receives the input gray scale level Si and calculates an image characteristic parameter (e.g., the transmittance that corresponds to the input gray scale), the control unit 66 sends a control signal Sc2 to the adjusting unit 63 according to the image characteristic parameter of the input gray scale level Si, and the adjusting unit 63 adjusts the waveforms of the first driving signal and the second driving signal according to the control signal Sc2. For example, the control unit 66 can determine the amplitude and/or pulse width of scan pulses generated by the scan line driver 5 base on the detected image characteristic parameter. The delay unit 64 enables the timing controller 61 and the adjusting unit 63 to synchronously control the scan line driving circuit 5. For example, the delay unit 64 delays the operation of the timing controller 61 to take into account of the delays from the detecting unit 65, the control unit 66, and the adjusting unit 63.

Advantages of the displays 2 (FIG. 10) and 90 (FIG. 12) can include one or more of the following. The displays have more consistent gamma curves when the displays are viewed from various viewing angles, as compared to displays having pixels each having only one display region. Although the pixels in the displays 2 and 90 each has two display regions, the number of data lines does not have to increase compared to displays having pixels each having only one display region. The gamma curves can be adjusted by changing the driving waveforms on the scan lines. This allows the displays to be easily optimized and configured according to customer requirements.

A number of implementations have been described. Nevertheless, it will be understood that various modifications may be made without departing from the spirit and scope of the invention. For example, various forms of the flows shown above may be used, with steps re-ordered, added, or removed. Also, although several applications and methods have been described, it should be recognized that numerous other applications are contemplated. For example, the transistors 111, 121, and 122 do not necessarily have to be thin film transistors, and can be other types of transistors or switches. The display does not necessarily have to be a liquid crystal display, and can be other types of displays. The gamma curves can be different from those described above. The voltage levels and signal waveforms can be different from those described above. Other implementations and applications are also within the scope of the following claims.

What is claimed is:

1. An apparatus comprising:
a display comprising
pixels each comprising a first display region and a second display region; and
a controller to control driving of the first and second display regions of each pixel to set the gray scale levels of the first and second display regions based on an overall gray scale level to be shown by the pixel, the controller setting the gray scale level of the second display region independently of the gray scale level of the first display region.

2. The apparatus of claim 1 in which the display comprises a look-up table that stores input gray scale values and corresponding gray scale levels of the first and second display regions, and the controller determines the gray scale levels for the first and second display regions based on the values in the look-up table.

3. The apparatus of claim 1 in which the first display region is associated with a first capacitor, the second display region is associated with a second capacitor and a third capacitor, the voltage level on the first capacitor determines the gray level shown by the first display region, the voltage level on the second capacitor determines the gray level shown by the second display region, and
the controller sets the gray scale levels of the first and second display regions by causing a first voltage level to be stored in the first and second capacitors and a second voltage level to be stored in the third capacitor, then causing the second and third capacitors to be electrically connected such that charges in the second and third capacitors are redistributed between the second and third capacitors.

4. The apparatus of claim 1 in which the first display region is associated with a first transistor electrically coupled to a first capacitor, the second display region is associated with a second transistor electrically coupled to a second capacitor and a third transistor electrically coupled to a third capacitor, and the controller turns on the first and second transistors for the same duration of time and turns on the third transistor for a duration of time that is different from the duration of time that the second transistor is turned on.

5. The apparatus of claim 1 in which the first display region is associated with a first transistor electrically coupled to a first capacitor, the second display region is associated with a second transistor electrically coupled to a second capacitor and a third transistor electrically coupled to a third capacitor, and the controller applies the same gate voltage to the first and second transistors and applies a gate voltage to the third transistor that is different from the gate voltage applied to the second transistor.

6. The apparatus of claim 1 in which the first display region is associated with a first transistor and a first capacitor, the first transistor having a gate terminal electrically coupled to a first scan line, a drain terminal electrically coupled to a data line, and a source terminal electrically coupled to the first capacitor, the first capacitor for storing a voltage level corresponding to the gray scale level of the first display region.

7. The apparatus of claim 6 in which the second display region is associated with a second transistor and a second capacitor, the second transistor having a gate terminal electrically coupled to the first scan line, a drain terminal electrically coupled to the data line, and a source terminal electrically coupled to the second capacitor, the second capacitor for storing a voltage level corresponding to the gray scale level of the second display region.

8. The apparatus of claim 7 in which the second display region is associated with a third transistor having a gate terminal electrically coupled to a second scan line, a drain terminal electrically coupled to the source terminal of the second transistor, and a source terminal electrically coupled to a third capacitor.

9. The apparatus of claim 8 in which the controller controls the first and second scan lines and the data line to turn on the first, second, and third transistors and cause voltage levels to be stored in the first, second, and third capacitors during a first time period, then controls the first and second scan lines to turn off the first and second transistors and turn on the third transistor to cause charges to be redistributed between the second and third capacitors during a second time period.

10. The apparatus of claim 9 in which the controller controls the first and second scan lines such that the second transistor is turned on for a length of time that is different from the length of time that the third transistor is turned on.

11. The apparatus of claim 9 in which the controller controls the first and second scan lines such that the voltage level on the first scan line is different from the voltage level on the second scan line while configuring a gray scale level of a pixel.

12. The apparatus of claim 1 in which each pixel comprises a liquid crystal cell.

13. A method of driving a display comprising:
for a given input gray level, determining a first gray level for a first display region of a pixel and a second gray level for a second display region of the pixel; and
driving the first and second display regions of each pixel to cause the first display region to have the first gray level and the second display region to have the second gray level such that the pixel has an overall gray level that approximates the input gray level.

14. The method of claim 13 in which determining the first gray level for the first display region and the second gray level for the second display region comprises searching a look-up table stored in memory to determine the first and second gray levels that correspond to the input gray level.

15. The method of claim 13 in which driving the first and second display regions comprises writing a first voltage level to a first capacitor associated with the first display region, writing the first voltage level to a second capacitor and a third capacitor associated with the second display region, and redistributing charges in the second and third capacitors.

16. The method of claim 13 in which driving the first and second display regions comprises
within a first period of time, driving a first scan line to turn on a first transistor associated with the first display region and a second transistor associated with the second display region, and driving a second scan line to turn on a third transistor associated with the second display region, and
within a second period of time, turning off the first transistor and the second transistor, and turning on the third transistor to allow charge redistribution to adjust a gray level of the second display region.

17. The method of claim 16 in which driving the first scan line and the second scan line comprises, during the first period of time, turning on the third transistor for a length of time that is different from the length of time that the first and second transistors are turned on during the first period of time.

18. The method of claim 16 in which driving the first scan line and the second scan line comprises, during the first period of time, driving the first scan line using a first voltage and driving the second scan line using a second voltage that is different from the first voltage.

19. The method of claim 13 in which driving the first and second display regions of a pixel comprises rotating liquid crystal molecules of the first and second display regions.

20. A method for driving a pixel of a display, the pixel comprising at least a first transistor, a second transistor, and a third transistor electrically connected to a first scan line, a second scan line, and a data line, the pixel having a first display region and a second display region, the method comprising:
within a first time period, providing a first driving signal through the first scan line and a second driving signal through the second scan line to turn on the first and second transistors, and writing pixel data into the first display region and the second display region through the data line; and
within a second time period, providing a third driving signal through the second scan line to turn on the third transistor to redistribute charges at two sides of the third transistor.

21. The method of claim 20 in which within the first period of time, the first driving signal changes from logic low to logic high at a first starting time, and the second driving signal changes from logic low to logic high at a second starting time that is different from the first starting time.

22. The method of claim 20 in which the first driving signal has a voltage level that is different from the voltage level of the second driving signal when the first and second driving signals turn on the first and second transistors.

23. The method of claim 20 in which within the first time period, the first driving signal is at logic high for a first period of time, and the second driving signal is at logic high for a second period of time that is different from the first period of time.

24. A method of driving a pixel comprising a first display region and a second display region, the first display region being associated with a first transistor and a first capacitor, the second display region being associated with a second transistor, a third transistor, a second capacitor, and a third capacitor, the first and second transistors having gate electrodes that are electrically connected to a first scan line, the third transistor having a gate electrode that is electrically connected to a second scan line, the method comprising:
providing a first driving signal through the first scan line and a second driving signal through the second scan line to turn on the first, second, and third transistors;
providing pixel data to the data line and writing the pixel data to the first display region and the second display region during a first time period; and
providing a third driving signal through the second scan line to turn on the third transistor to enable redistribution of charges at two sides of the third transistor during a second time period.

25. The method according to claim 24 in which the first driving signal changes from a logic low to a logic high at a first starting time, the second driving signal changes from a logic low to a logic high at a second starting time that is different from the first starting time.

26. The method according to claim 24 in which the first driving signal has a voltage level that is different from the voltage level of the second driving signal when the first and second driving signals turn on the first, second, and third transistors.

27. The method according to claim 24 in which the first driving signal is at logic high for a first period of time, and the second driving signal is at logic high for a second period of time that is different from the first period of time.
